(19) United States
(12) Patent Application Publication
(10) Pub. No.: US 2011/0081151 A1
(43) Pub. Date: Apr. 7, 2011

(54) Generation and Coherent Detection of High-Speed Orthogonal DWDM Optical Signal

(75) Inventors: Jianjun Yu, Princeton, NJ (US); Ming-Fang Huang, Atlanta, GA (US); Ting Wang, West Windsor, NJ (US)

(73) Assignee: NEC LABORATORIES AMERICA, INC., Princeton, NJ (US)

(21) Appl. No.: 12/894,508

(22) Filed: Sep. 30, 2010

Related U.S. Application Data
(60) Provisional application No. 61/247,260, filed on Sep. 30, 2009.

(51) Int. Cl. H04J 14/02

(52) U.S. Cl. 398/79

(57) ABSTRACT

A high speed orthogonal dense wavelength division multiplexing DWDM signal generator includes a multi-peak continuous wave signal generator responsive to a light source, an optical filter for separating multi-peaks of lightwaves from the generator; and a polarization multiplexing stage responsive to the multi-peaks of lightwaves from the optical filter for providing a polarization multiplexing optical signal. The generator includes a cascaded phase modulator and intensity modulator driven by a repetitive frequency (I) to generate multiple spectral peaks, each peak being modulated by an optical modulator driven by a respective baud rate (f baud/s) electrical signal.

This application claims the benefit of U.S. Provisional Application No. 61/247,260, entitled “1.2-Tb/S Single Channel PDM-RZ-QPSK Signal Transmission over 1040 km SMF-28”, filed on Sep. 30, 2009, the contents of which are incorporated by reference herein.

### FIELD OF THE INVENTION

The present invention relates generally to optical communications, and more particularly, to generation and coherent detection of a high speed orthogonal dense wavelength division multiplexing DWDM optical signal.

### BACKGROUND OF THE INVENTION

One (1) Terabit per second (Tb/s) per channel or higher is a possible bit rate for long-haul (LH) optical transmission after 100 Gigabit Ethernet (GbE). To generate a single carrier 1 Tb/s optical signal, even if polarization diversity (PD) and 64QAM modulation format are employed, the baud rate per carrier still goes up to 100 Gig baud/s (with forward error correction FEC consideration). The bandwidth of the analog/digital converter (ADC) chip at this rate is not available in the near future. Also, the transmission distance of this single carrier is short due to a high optical signal-to-noise ratio (OSNR) requirement. To use multiple peaks or multiple frequency orthogonal subchannels to transmit high-bit rate is a good solution.

In a publication by J. Yu, X. Zhou, L. Xu, P. N. Ji and T. Wang, “A novel scheme to generate 100 Gbit/s DQPSK signal with large PMD tolerance”, in Proc OFC, paper JThA42 (2007). IR No. 7071 entitled “Generation of at least 100 Gbit/s Optical Transmission Channel”, there was disclosed a a 100-Gb/s transmitter with two peaks to tolerant large polarization mode dispersion and fiber dispersion.

In a publication by J. Yu, et all., 400 Gb/s (4×100 Gb/s) orthogonal PDM-RZ-QPSK DWDM Signal Transmission over 1040 km SMF-28, Optics Express, there was disclosed a 400 Gb/s per channel signal generation, where the four peaks are generated by one phase modulator.

In a publication by H. Masuda, E. Yamazaki, A. Sano, T.Yoshimatsu, T. Kobayashil, E. Yoshidal, Y. Miyamoto, S. Matsuoka, Y. Takatori, M. Mizoguchi, K. Okada, K. Hagimoto, T. Yamada, S. Kamei;, “13.5-Tb/s (135×111-Gb/s/ch) no-guard-interval coherent OFDM transmission over 6248 km using SNR maximized second-order DRA in the extended L-band”, in Proc OFC, paper PDPB5 (2009), there was disclosed a 100-Gb/s signal with two peaks optical OFDM signal.

In publications by G. Goldfarb, G. Li, M. G. Taylor, “Orthogonal Wavelength-Division Multiplexing Using Coherent Detection”, IEEE Photonics Technology Letters, Vol. 19, No. 24, Page(s): 2015-2017, Dec. 15, 2007 and Y. Tang and W. Shieh, “Coherent Optical OFDM Transmission Up to 1 Tb/s per Channel,” in proc OFC, paper PDPC1 (2009), there was disclosed a 1Tb/s optical signal generation by using re-circulating frequency shifting (RFS) based on frequency conversion in a single sideband modulator.

Given the above disclosed techniques of using multiple peaks or multiple frequency orthogonal subchannels to transmit a high bit, nevertheless, there is a need for a simpler configuration that reduces the baud rate and extends the transmission distance.

### SUMMARY OF THE INVENTION

In one aspect of the invention, an orthogonal dense wavelength division multiplexing DWDM signal generator includes a multi-peak continuous wave signal generator responsive to a light source, an optical filter for separating multi-peaks of lightwaves from the generator, and a polarization multiplexing stage responsive to the multi-peaks of lightwaves from the optical filter for providing a polarization multiplexing optical signal. The generator includes a cascaded phase modulator and intensity modulator driven by a repetitive frequency (I) to generate multiple spectral peaks, each peak being modulated by an optical modulator driven by a respective baud rate (f baud/s) electrical signal.

In an alternative aspect of the invention, a method for generating an orthogonal dense wavelength division multiplexing DWDM signal includes generating a multi-peak continuous wave signal responsive to a light source, separating multi-peaks of lightwaves from the generating step, and providing a polarization multiplexing optical signal with a polarization multiplexing stage responsive to the multi-peaks of lightwaves from the separating step. The generating step including a cascaded phase modulator and intensity modulator driven by a repetitive frequency (I) to generate multiple spectral peaks, each peak being modulated by an optical modulator driven by a respective baud rate (f baud/s) electrical signal.

### BRIEF DESCRIPTION OF DRAWINGS

These and other advantages of the invention will be apparent to those of ordinary skill in the art by reference to the following detailed description and the accompanying drawings.

FIG. 1 is a block diagram of an exemplary high speed orthogonal DWDM system employing high speed signal generation and coherent detection, in accordance with the invention.

### DETAILED DESCRIPTION

The invention is directed to the use of a cascaded phase modulator and intensity modulator driven by a repetitive frequency (f) to generate multiple spectral peaks, wherein each peak is modulated by an optical modulator driven by a certain baud rate (f baud/s) electrical signal.

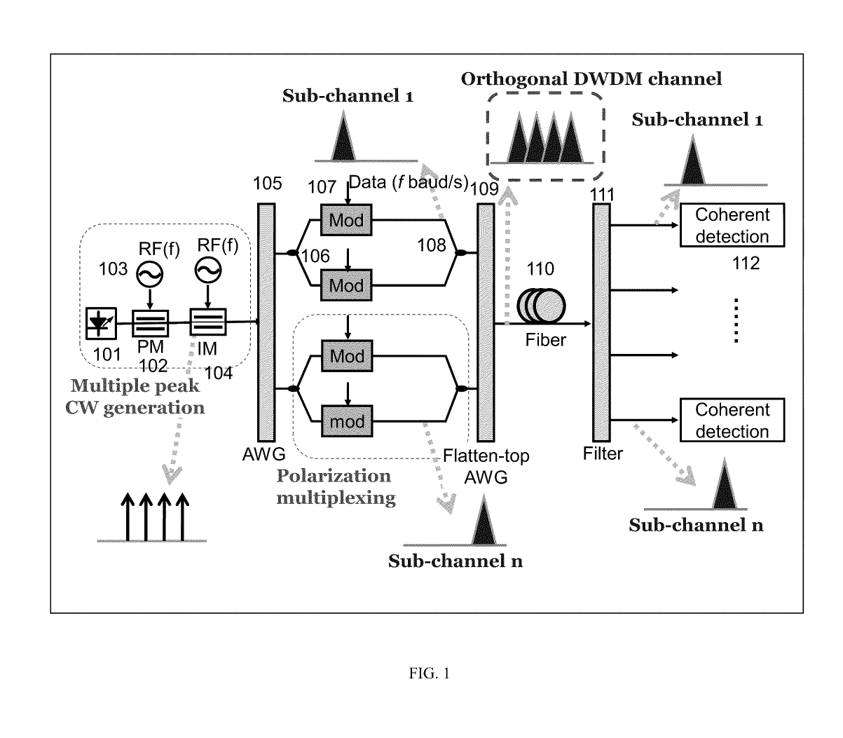

FIG. 1 shows an exemplary configuration for high-speed orthogonal DWDM signal generation and detection, in accordance with the invention.

The laser source 101 can be a DFB-LD which usually has line width that is wide. For a 100 Gbit/s QPSK, a line width smaller than 2 MHz is fine. This type of laser source is difficult to use for high-level modulation format. Alternatively, the laser source 101 can be a tunable external laser with narrow line width and low phase noise, which is preferred for high level modulation format signals. The DFB-LD is less expensive than the tunable external laser source.

The phase modulator 102 is used to generate multiple peaks. This phase modulator should be driven by proper a power RF source with a repetitive frequency off To generate a large number peaks from the phase modulator, the RF power should be high. Preferably, it should be a few times of a half-wave voltage of the phase modulator.

The RF signal 103 is used to drive the external modulator. The optical signal with multiple peaks will be generated after the external modulator. These peaks have a frequency spacing equal to the repetitive frequency of the RF signal. The optical filter 105 which is used to separate these multi-peaks. can be an array waveguide grating, a DWDM filter or other optical filter.

The modulator 107 is used to generate a modulated optical signal. The baud rate has to be equal to a certain number to make the WDM signals orthogonal. Here, the baud rate should be f baud/s. For example, if the repetitive frequency f is 25 GHz, the baud rate of the modulated signal should be 25 Gbaud/s. This modulation signal can be any optical signal, such as regular On/off keying NRZ signal, QPSK, 8PSK, 8QAM, 16QAM, 64QAM or higher.

The intensity modulator 104 is driven by the same repetitive frequency of f. This intensity modulator is used to cascade the phase modulator to generate a multi-peak flattened optical spectrum.

The optical coupler 106 is used to separate one lightwave into two lightwaves. A polarization maintaining 50:50% optical coupler is optimal. The polarization beam coupler 108 is used to combine the two lightwaves to have an orthogonal polarization direction to generate a polarization multiplexing optical signal.

The optical combiner 109 is used to combine these subchannels. It can be an optical coupler, DWDM filter, or AWG. Here a flat top optical component is optimal. When a flat top AWG is used, the receiver sensitivity will be high.

The transmission fiber 110 can be any transmission fiber, such as a standard single mode fiber, LEAF, or other fiber. In order to compensate for transmission loss, optical amplifiers are needed.

The optical filter 111 is used to separate these orthogonal subchannels and can be an optical coupler, DWDM filter, or AWG. Here a flat top optical component is optimal. When a flat top AWG is used, the receiver sensitivity will be high.

The digital coherent detector 112 includes a polarization diversity hybrid modulator, one local oscillator, photodiodes, high speed AD and other optical or electrical components (not shown)

Referring again to FIG. 1, a single-mode CW Lightwave (101) is modulated by the phase modulator (PM) (102) cascaded by the intensity modulator (IM) (104) driven by the sinusoidal RF source (103) with a repetitive frequency off Note that the position of 102 and 104 can be exchanged. With a proper large driving voltage on this PM, a CW lightwave carried by multiple spectral peaks can be generated in a fixed frequency spacing (equal to f) and equal amplitude.

For a 1Tb/s orthogonal DWDM signal transmitter, if each subchannel carries over 100-Gb/s signal, we need ten peaks. The ten peaks will be separated into ten lightwaves by an array waveguide grating (AWG) or a DWDM filter (105). Each lightwave will be modulated individually by the modulator (107) and polarization multiplexing scheme to generate a polarization diversity optical signal. the modulator 107 is used to generate the modulated optical signal. The baud rate has to be equal to a certain number to make the WDM signals are orthogonal in frequency. Here, the baud rate should be f baud/s if the repetitive frequency of the RF signal on 102 or 104 is f For example, if the repetitive frequency f is 25 GHz, the baud rate of the modulated signal should be 25 Gbaud/s. This modulation signal can be any optical signal, such as regular On/off keying NRZ signal, QPSK, 8PSK, 8QAM, 16QAM, 64QAM or higher. 106 is a polarization maintaining optical coupler. 108 is a polarization beam combiner.

The generated subchannels will be combined by the optical combiner 109, for instance, an optical coupler, DWDM filter, or AWG. Here a flat top optical combiner is optimal. The sub-channels are combined and transmitted over the fiber (110) to the receiver. At the receiver, the orthogonal DWDM subchannels are demultplexed before each subchannel is detected. We use the optical filter or an AWG (111) to separate these orthogonal DWDM subchannels. Each subchannel can then be detected by the regular coherent detection (112).

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

What is claimed is:

1. An orthogonal dense wavelength division multiplexing DWDM signal generator comprising:
a multi-peak continuous wave signal generator responsive to a light source,
an optical filter for separating multi-peaks of lightwaves from said generating; and
a polarization multiplexing stage responsive to said multi-peaks of lightwaves from said optical filter for providing a polarization multiplexing optical signal;
said generator comprising a cascaded phase modulator and intensity modulator driven by a repetitive frequency (f) to generate multiple spectral peaks, each peak being modulated by an optical modulator driven by a respective baud rate (f baud/s) electrical signal.

2. The signal generator of claim 1, wherein said phase modulator comprises being driven by a RF source with said repetitive frequency f a number of said multi-peaks being responsive to a power level of said RF source.

3. The signal generator of claim 2, wherein said number of said multi-peaks increases with an increase of said power of said RF source.

4. The signal generator of said claim 2, wherein said power level of said RF source is based on a multiple of a half-wave voltage of said phase modulator.

5. The signal generator of claim 1, wherein said intensity modulator cascades said phase modulator to generate a multi-peak flattened optical spectrum.

6. The signal generator of claim 1, wherein said light source is a distributed feedback laser diode providing a line width equal to or smaller than 2 MHz.

7. The signal generator of claim 1, wherein said repetitive frequency is 25 GHz and said baud rate is 25 Gbaud/s.

8. The signal generator of claim 1, wherein for at least a one (1) Tb/s signal output by said signal generator said multiple spectral peaks numbering at least ten (10) and each said spectral peak being a subchannel carrying at least a 100 Gb/s signal.

9. A method for generating an orthogonal dense wavelength division multiplexing DWDM signal, said method comprising the steps of:
generating a multi-peak continuous wave signal responsive to a light source,
separating multi-peaks of lightwaves from said generator; and
providing a polarization multiplexing optical signal with a polarization multiplexing stage responsive to said multi-peaks of lightwaves from said optical filter;
said generating comprising a cascaded phase modulator and intensity modulator driven by a repetitive frequency (f) to generate multiple spectral peaks, each peak being modulated by an optical modulator driven by a respective baud rate (f baud/s) electrical signal.

10. The method of claim 9, wherein said phase modulator comprises being driven by a RF source with said repetitive frequency f a number of said multi-peaks being responsive to a power level of said RF source.

11. The method of claim 10, wherein said number of said multi-peaks increases with an increase of said power of said RF source.

12. The method of said claim 10, wherein said power level of said RF source is based on a multiple of a half-wave voltage of said phase modulator.

13. The method of claim 9, wherein said intensity modulator cascades said phase modulator to generate a multi-peak flattened optical spectrum.

14. The method of claim of claim 9, wherein said light source is a distributed feedback laser diode providing a line width equal to or smaller than 2 MHz.

15. The method of claim 9, wherein said repetitive frequency is 25 GHz and said baud rate is 25 Gbaud/s.

16. The method of claim 9, wherein for at least a one (1) Tb/s signal output by said signal generator said multiple spectral peaks numbering at least ten (10) and each said spectral peak being a subchannel carrying at least a 100 Gb/s signal.
